(19) United States
(12) Patent Application Publication
(10) Pub. No.: US 2007/0165270 A1
(43) Pub. Date: Jul. 19, 2007

(54) Image forming apparatus, system and method using printing layout templates

(75) Inventor: Dae-Hyun Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/585,864

(22) Filed: Oct. 25, 2006

(30) Foreign Application Priority Data
Jan. 18, 2006 (KR) 10-2006-0005409

(51) Int. Cl. G06F 3/12; G06F 17/00

(52) U.S. Cl. 358/1.15; 715/517; 715/526

(57) ABSTRACT

An image forming apparatus, system and method using printing layout templates are provided. The system includes a communication device determining a layout template for printing an image from a layout template list and transmitting the image and the information on the determined layout template, and an image forming apparatus providing the layout template list for the communication device, forming an image layout by using the information transmitted from the communication device, and printing the image with the image layout. When a wireless network, such as a Bluetooth network, is established and a user desires to output an image from a communication device to an image forming apparatus, the image forming system and apparatus can display various types of image layouts which can be used for printing the image by the user.

### CROSS-REFERENCE TO RELATED PATENT APPLICATIONS

This application claims the benefit under 35 U.S.C. § 119(a) of Korean Patent Application No. 10-2006-0005409, filed Jan. 18, 2006, in the Korean Intellectual Property Office, the entire disclosure of which is hereby incorporated by reference.

### BACKGROUND OF THE INVENTION

1. Field of the Invention

The present invention relates to printing an image transmitted from a communication device. More particularly, the present invention relates to an image forming system and method for printing images with various layouts.

2. Description of the Related Art

With the advances of communication devices and photo printers, a direct printing function and corresponding hardware have been developed to allow a user to print pictures without the need to use a computer.

In conventional direct printing, image data is transmitted to an image forming apparatus through a network such as a Bluetooth network.

However, in conventional image forming apparatuses, image layout for printing is predetermined. Thus, a user has to print selected images with only the predetermined layout. And although the printing pattern of the layout is simple, the user cannot print images with various layouts. Further, since the image layout received from a communication device is not displayed, the printed image may differ from the actual image.

### SUMMARY OF THE INVENTION

Exemplary embodiments of the present invention provide an image forming system and method capable of displaying various types of image layouts for printing image data transmitted from a communication device to the image forming apparatus.

Exemplary embodiments of the present invention provide an image forming system including a communication device determining a layout template for printing an image from a layout template list and transmitting the image and the information on the determined layout template. The system further includes an image forming apparatus providing the layout template list for the communication device, forming an image layout by using the information transmitted from the communication device, and printing the image with the image layout.

Exemplary embodiments of the present invention provide an image forming method including requesting a layout template list from an image forming apparatus, transmitting the layout template list to a communication device, determining a layout template for printing an image from the layout template list and transmitting the image and information on the determined layout template to the image forming apparatus. In an exemplary implementation the method provides for printing an image layout by using the information transmitted from the communication device.

### BRIEF DESCRIPTION OF THE DRAWINGS

The above and other exemplary features and advantages of the present invention will become more apparent from the following detailed description of certain exemplary embodiments thereof when taken in conjunction with the accompanying drawings, in which:

FIG. 1 is a block diagram of an image forming system according to an exemplary embodiment of the present invention;

FIG. 2 shows a layout template list according to an exemplary embodiment of the present invention;

FIG. 3 is a flowchart of an image forming method according to an exemplary embodiment of the present invention;

FIG. 4 is a flowchart of operation 304 shown in the exemplary embodiment of FIG. 3 according to an exemplary embodiment of the present invention;

FIG. 5 is a flowchart of operation 306 shown in the exemplary embodiment of FIG. 3 according to an exemplary embodiment of the present invention; and

FIG. 6 shows a process of displaying and printing an image layout, performed between a communication device and an image forming apparatus according to an exemplary implementation of the present invention.

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

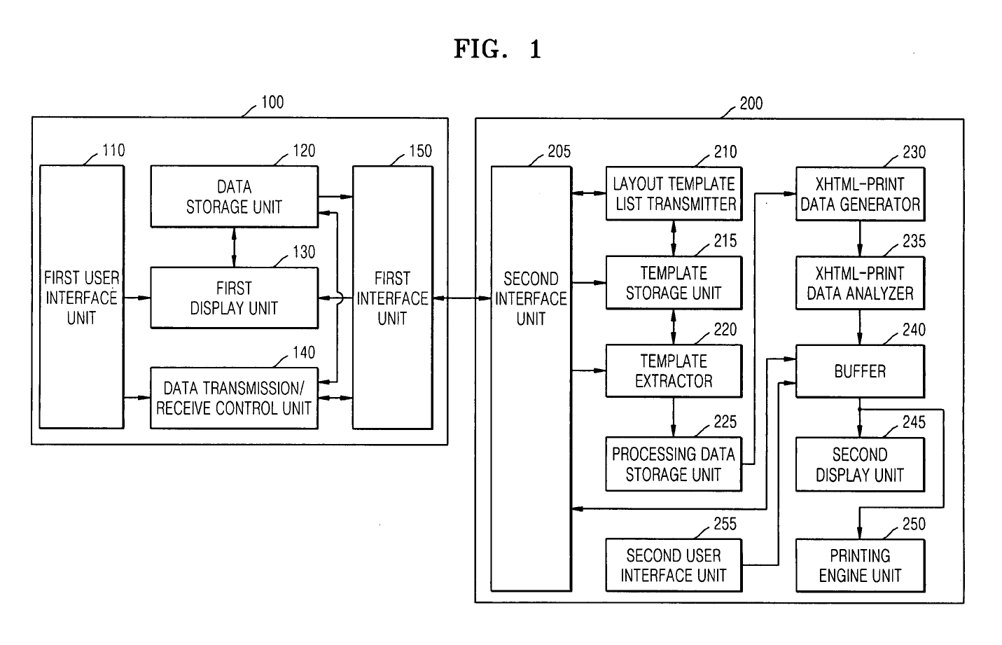

FIG. 1 is a block diagram of an image forming system according to an exemplary embodiment of the present invention. The image forming system includes a communication device 100 and an image forming apparatus 200.

The communication device 100 selects a layout template for printing an image from a layout template list and transmits the image and information on the selected layout template to the image forming apparatus 200.

The layout template list includes key values corresponding to template options.

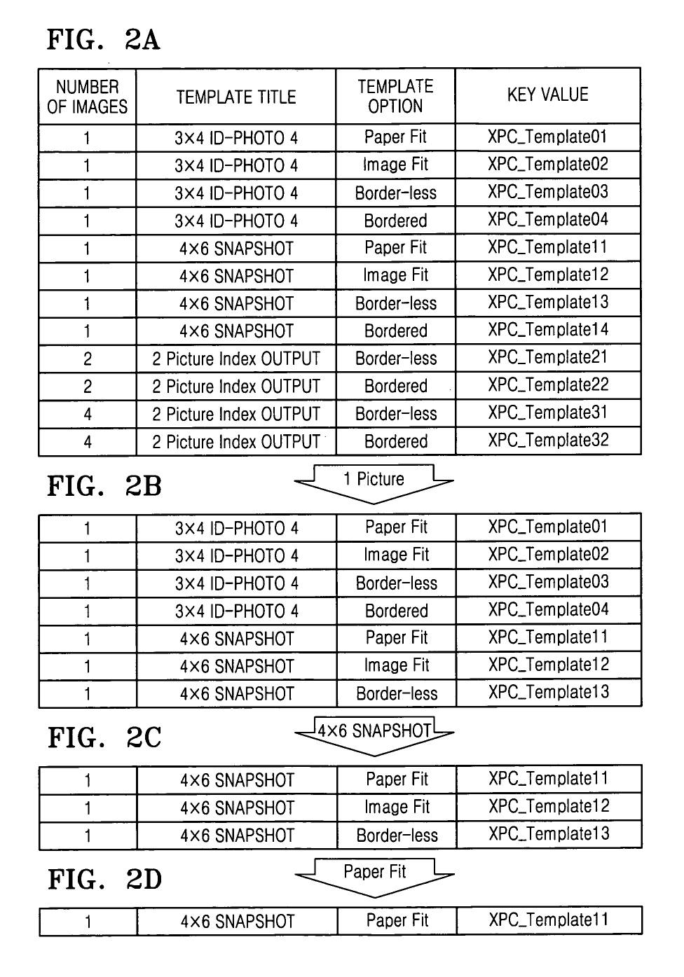

FIG. 2 shows a layout template list according to an exemplary embodiment of the present invention. As shown in FIG. 2, the key values are allocated to template options.

The communication device 100 can be a mobile phone, a personal digital assistant (PDA), or a notebook computer.

The communication device 100 includes a first user interface unit 110, a data storage unit 120, a first display unit 130, a data transmission/receive control unit 140, and a first interface unit 150. The first user interface unit 110 receives a control command from a user. The control command from the user can be, for example, a control command for requesting the layout template list from the image forming apparatus 200, a command for printing the image, a command for displaying the image, a command for selecting the image to be printed, and a command for selecting the layout template from the layout template list by the user.

The data storage unit 120 stores data of the image and outputs the image to the image forming apparatus 200 through the first interface unit 150 in response to the control signal.

The first display unit 130 displays the image and the layout template list. When receiving the user's command for displaying the image from the first user interface unit, the first display unit 130 displays the image stored in the data storage unit 120. When receiving the layout template list from the image forming apparatus 200, the first display unit 130 displays the layout template list so that the user can see the layout template list.

The first display unit 130 receives the image layout formed by the image forming apparatus 200 and displays the image layout.

The data transmission/receive control unit 140 requests the layout template list from the image forming apparatus 200, controls that the image is transmitted to the image forming apparatus 200, or controls the information on the selected layout template to be transmitted to the image forming apparatus 200.

When receiving a request for the layout template list through the first user interface unit 110, the data transmission/receive control unit 140 requests the layout template list from the image forming apparatus 200.

When receiving a command for selecting an image through the first user interface unit 110, the data transmission/receive control unit 140 outputs a signal for controlling that the image selected from the images stored in the data storage unit 120 is transmitted to the image forming apparatus 200 to the data storage unit. The data storage unit 120 outputs the selected image to the image forming apparatus 200 through the first interface unit 150 in response to the control signal from the data transmission/receive control unit.

When receiving a command for determining a layout template, the data transmission/receive control unit 140 controls the information on the layout template corresponding to the command for determining the template to be transmitted to the image forming apparatus 200 through the first interface unit 150. When the layout template list shown in FIG. 2A is displayed on the first display unit 130, the user can select the desired layout template. FIGS. 2B to 2D show a process in which the user selects the layout template. When the layout template shown in FIG. 2D is finally selected, the data transmission/receive control unit 140 controls the information corresponding to the selected layout template to be transmitted to the image forming apparatus 200 through the first interface unit 150.

The first interface unit 150 interfaces the mobile communication device 100 with the image forming apparatus 200 to transmit/receive data.

The image forming apparatus 200 provides the layout template list for the communication device 100, displays the image layout by using the information transmitted from the communication device 100, and prints the image layout.

In an exemplary implementation, the image forming apparatus 200 includes a second interface unit 205, a layout template list transmitter 210, a template storage unit 215, a template extractor 220, a processing data storage unit 225, an extensible hypertext markup language (XHTML)-Print data generator 230, an XHTML-Print data analyzer 235, a buffer 240, a second display unit 245, a printing engine unit 250, and a second user interface unit 255.

The second interface unit 205 interfaces the communication device 100 with the image forming apparatus 200 to transmit/receive data.

The template storage unit 215 stores layout templates. The layout templates are various templates for forming layouts of the images. In an exemplary implementation, the layout templates are stored in the format of XHTML-Print data.

The layout template list transmitter 210 transmits the layout template list to the mobile communication device 100. When receiving the request for the layout template list from the communication device 100, the layout template list transmitter 210 transmits the list of the layout templates stored in the template storage unit 215 to the communication unit 100 through the second interface unit 205.

The template extractor 220 extracts the layout template corresponding to the information which is received from the communication device 100 from the layout templates in the template storage unit 215 and outputs the extracted result to the processing data storage unit 225.

The processing data storage unit 225 stores the image transmitted from the communication device 100 and the layout template extracted from the template extractor 220. The processing data storage unit 225 outputs the image and the layout template to the XHTML-Print data generator 230.

The XHTML-Print data generator 230 generates XHTML-Print data of the image layout corresponding to the extracted layout template and outputs the generated XHTML-Print data to the XHTML-print data analyzer 235. The XHTML-print data generator 230 generates the XHTML-Print data of the desired layout by using the extracted layout template and the image.

The XHTML-Print data analyzer 235 analyzes the XHTML-Print data generated from the XHTML-Print data generator 230 and outputs the analyzed XHTML-Print data to the buffer 240.

The buffer 240 temporarily stores the analyzed XHTML-Print data and outputs the XHTML-Print data to the second display unit 245.

When receiving the printing command from the communication device 100, the buffer 240 outputs the analyzed XHTML-Print data to the printing engine unit 250. In addition, when receiving the printing command from the second user interface unit 255, the buffer 240 outputs the analyzed XHTML-Print data to the printing engine unit 250.

The buffer 240 outputs the image layout of the analyzed XHTML-Print data to the second interface unit 205. The second interface unit 205 transmits the image layout received from the buffer 240 to the communication device 100. The first display unit 130 of the communication unit 100 displays the image layout received from the image forming apparatus 200. The user can recognize whether the layout is the desired layout by confirming the displayed image layout through the first display unit 130.

The second display unit 245 displays the image layout corresponding to the XHTML-Print data received from the buffer 240. The user can recognize whether the layout is the desired layout by confirming the displayed image layout through the second display unit 245. When determining that the layout is the desired layout, the user can input the printing command through the first user interface unit of the communication unit 100 or the second user interface unit 255 of the image forming apparatus 200.

The printing engine unit 250 prints the image layout in response to the printing command input through the first user interface unit 110 or the second user interface unit 255.

The second user interface unit 255 in the image forming apparatus receives the printing command from the user and outputs the printing command to the buffer 240. The buffer 240 outputs the stored XHTML-Print data to the printing engine unit 250. The printing engine unit 250 prints the image layout corresponding to the XHTML-Print data.

Hereinafter, an image forming method according to the present invention will be described in detail with reference to the accompanying drawings.

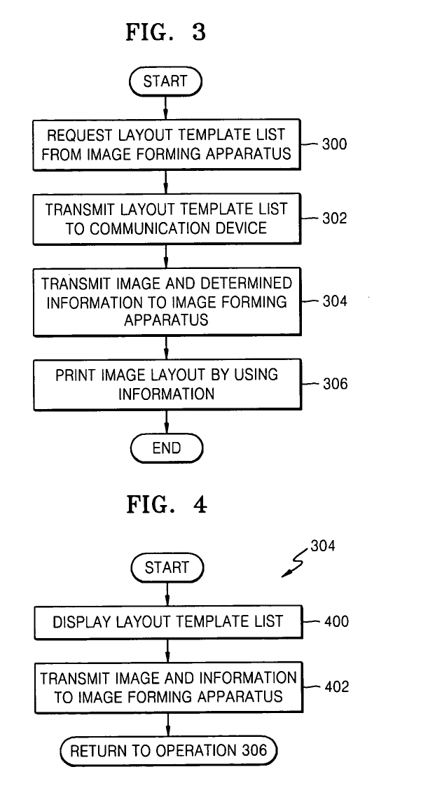

FIG. 3 is a flowchart of an image forming method according to an exemplary embodiment of the present invention.

First, the communication device 100 requests the layout template list from the image forming apparatus (step 300).

The layout template list includes the key values corresponding to the template options.

After step 300, the layout template list is transmitted to the communication device 100 (step 302). The list of the layout templates stored in the template storage unit 215 is transmitted to the communication device 100.

After step 302, the layout template for printing the image is determined from the layout template list, and the image and the information on the determined layout template is transmitted to the image forming apparatus 200 (step 304).

FIG. 4 is a flowchart of an exemplary implementation of transmitting an image and determined information to the image forming apparatus, step 304 shown in the exemplary embodiment of FIG. 3, according to an exemplary embodiment of the present invention. First, the layout template list is displayed (operation 400).

After step 400, the information on the layout template determined in the displayed layout template list and the image are transmitted to the image forming apparatus (step 402).

When the layout template list shown in FIG. 2A is displayed, the user can select the desired layout template. As shown in FIGS. 2B to 2D, when the layout template is selected, the information on the selected layout template is transmitted to the image forming apparatus 200. In addition, the image corresponding to the image selection command is transmitted to the image forming apparatus 200.

After step 304, the image layout can be printed by using the information transmitted from the communication device (step 306).

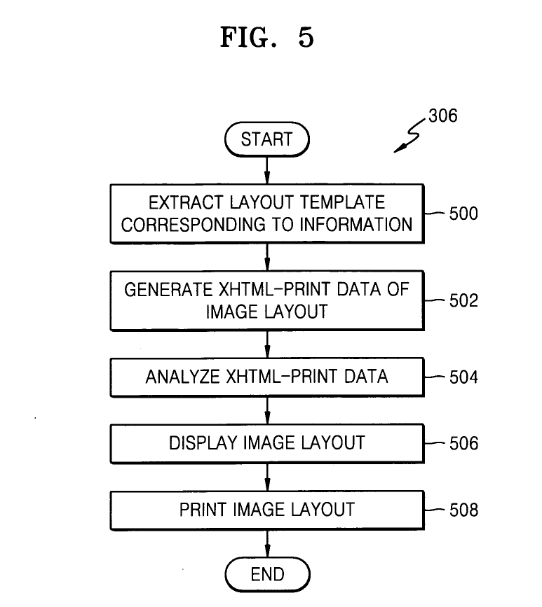

FIG. 5 is a flowchart of an exemplary implementation of printing an image layout using information transmitted, step 306 shown in the exemplary embodiment of FIG. 3, according to an exemplary embodiment of the present invention.

First, the layout template corresponding to the information received from the communication device 100 is extracted from the layout templates (step 500).

After step 500, the XHTML-Print data of the image layout corresponding to the extracted layout template is generated (step 502).

After step 502, the generated XHTML-Print data is analyzed (step 504).

After step 504, the image layout corresponding to the analyzed XHTML-Print data is displayed on the image forming apparatus (step 506). Step 506 can further include an operation of transmitting the image layout to the communication device 100. When the image layout is transmitted to the communication device, the communication device 100 displays the image layout. The user can determine whether the image layout is the desired layout by confirming the displayed image layout. After determining that the image layout is the desired layout, the user provides the printing command through the first user interface unit 110 of the communication device 100 or the second user interface unit 255 of the image forming apparatus 200.

After step 506, the image layout can be printed (step 508).

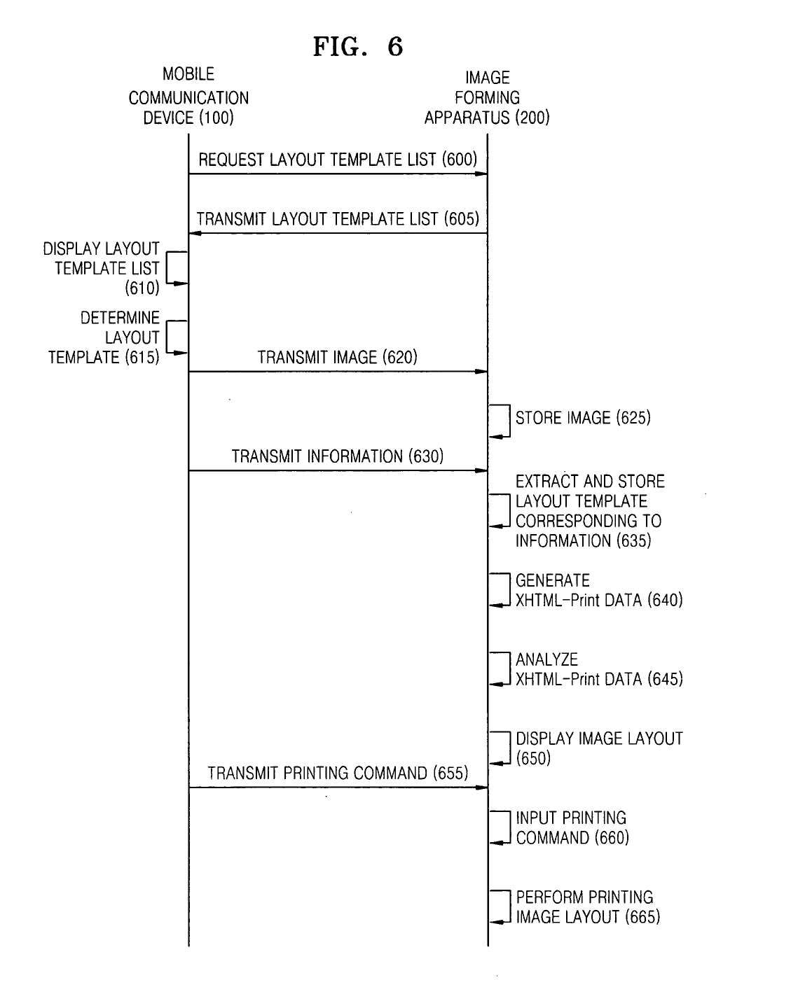

FIG. 6 shows a process of displaying and printing an image layout, performed between a communication device and an image forming apparatus according to an exemplary implementation of the present invention.

When a communication device 100 requests a layout template list from an image forming apparatus 200, step 600, the image forming apparatus 200 transmits the layout template list to the communication device 100, step 605. The layout template list is displayed on the communication device 100, step 610, and the layout template is determined by the user, step 615. The image is transmitted to the image forming apparatus 200, step 620, and is stored in the image forming apparatus 200, step 625. In addition, the information on the determined layout template is also transmitted to the image forming apparatus 200, step 630, and the layout template corresponding to the information is extracted, step 635. The XHTML-Print data is generated by the use of the image and the extracted layout, step 640. The generated XHTML-Print data is analyzed, step 645. The image layout corresponding to the analyzed XHTML-Print data is displayed, step 650. Then, the printing command is received from the user, steps 655, 660, and the image layout is printed, step 665.

Exemplary embodiments of the present invention can also be embodied as computer readable codes/instructions/programs on a computer readable medium and can be implemented in computers that execute the codes/instructions/programs. Examples of the computer readable medium include magnetic storage media (for example, read-only memory (ROM), random-access memory (RAM), floppy disks, magnetic tapes, hard disks, among others), optical recording media (for example, CD-ROMs and DVDs), and communications signals such as carrier waves (for example, transmission through the Internet). Exemplary embodiments of the present invention can also be embodied as computer readable codes/instructions/programs distributed over network coupled computer systems and executed in a distributed fashion.

While the present invention has been particularly shown and described with reference to certain exemplary embodiments thereof, it will be understood by those of ordinary skill in the art that various changes in form and detail may be made therein without departing from the spirit and scope of the present invention as defined by the following claims and equivalents thereof.

When a wireless network such as a Bluetooth network is established, and it is desired to output an image from the communication device to the image forming apparatus, the image forming system and apparatus according to exemplary embodiments of the present invention can display various types of image layouts which can be used for printing the image by the user.

An image forming system and apparatus according to exemplary embodiments of the present invention can prevent unnecessary printing and reduce waste of paper by confirming the image layout before printing the image layout.

What is claimed is:

1. An image forming system comprising:
a communication device for determining a layout template for printing an image from a layout template list and transmitting the image and information on the determined layout template; and
an image forming apparatus for providing the layout template list for the communication device, wherein the image forming apparatus forms an image layout by using the information transmitted from the communication device.

2. The system of claim 1, wherein the layout template list includes key values corresponding to template options.

3. The system of claim 1, wherein the communication device comprises:
a data storage unit for storing data of the image;
a first display unit for displaying the image and the layout template list;
a first user interface unit for receiving a control command of a user;
a first interface unit for interfacing with the image forming apparatus to transmit/receive data; and
a data transmission/receive control unit for controlling a request for the layout template list and controlling for transmitting the image and the information to the image forming apparatus.

4. The system of claim 3, wherein the first display unit receives the image layout from the image forming apparatus and displays the image layout.

5. The system of claim 1, wherein the communication device comprises at least one of a mobile phone, a personal digital assistant (PDA), and a notebook computer.

6. The system of claim 1, wherein the image forming apparatus comprises:
a second interface unit for interfacing with the communication device to transmit/receive data;
a template storage unit for storing the layout templates;
a layout template list transmitter for transmitting the layout template list to the communication device;
a template extractor for extracting the layout template corresponding to the information which is received from the communication device from the layout templates stored in the template storage unit;
a processing data storage unit for storing the image transmitted from the communication device and the layout template extracted by the template extractor;
an extensible hypertext markup language (XHTML)-Print data generator for generating XHTML-Print data of the image layout corresponding to the stored layout template;
an XHTML-print data analyzer for analyzing the generated XHTML-Print data;
a buffer for temporarily storing the analyzed XHTML-Print data; and
a printing engine unit for printing the image layout.

7. The system of claim 6, wherein the image forming apparatus further comprises a second display unit for displaying the image layout corresponding to the analyzed XHTML-Print data.

8. The system of claim 6, wherein the image forming apparatus further comprises a second user interface unit for receiving a printing command from a user.

9. An image forming method comprising:
requesting a layout template list from an image forming apparatus;
transmitting the layout template list to a communication device;
determining a layout template for printing an image from the layout template list;
transmitting the image and information on the determined layout template to the image forming apparatus; and
printing an image layout by using the information transmitted from the communication device.

10. The method of claim 9, wherein the layout template list includes key values corresponding to template options.

11. The method of claim 9, wherein determining a layout template comprises:
displaying the layout template list; and
transmitting the image and the information on the layout template determined from the layout template list to the image forming apparatus.

12. The method of claim 9, wherein printing an image layout comprises:
extracting the layout template corresponding to the information received from the communication device from the layout templates;
generating an extensible hypertext markup language (XHTML)-Print data of the image layout corresponding to the extracted layout template;
analyzing the generated XHTML-Print data; and
printing the image layout corresponding to the analyzed XHTML-Print data.

13. The method of claim 12, further comprising displaying the image layout.

14. The method of claim 12, further comprising transmitting the image layout to the communication device,
wherein the communication device displays the received image layout.

15. A computer-readable medium having stored thereon a computer program for executing the method of claim 9.

16. The system of claim 3, wherein the data storage unit outputs the image to the image forming apparatus through the first interface unit in response to a control signal.

17. The method of claim 9 further comprising:
receiving a control command, the control command comprising a command for requesting the layout template list from the image forming apparatus, a command for printing the image, a command for displaying the image, a command for selecting the image to be printed, and a command for selecting the layout template from the layout template list.

18. A communication device comprising:
a data storage unit for storing data of an image;
a first display unit for displaying the image and a layout template list;
a first user interface unit for receiving a control command of a user;
a first interface unit for interfacing with an image forming apparatus to transmit/receive data; and
a data transmission/receive control unit for controlling a request for the layout template list and controlling for transmitting the image and the information to the image forming apparatus.

19. An image forming apparatus comprising:
a second interface unit for interfacing with a communication device to transmit/receive data;
a template storage unit for storing at least one layout template;
a layout template list transmitter for transmitting a layout template list to the communication device;
a template extractor for extracting the layout template corresponding to information received from the communication device from the at least one layout template stored in the template storage unit;
a processing data storage unit for storing an image transmitted from the communication device and the layout template extracted by the template extractor;
an extensible hypertext markup language (XHTML)-Print data generator for generating XHTML-Print data of an image layout corresponding to the at least one stored layout template;
an XHTML-print data analyzer for analyzing the generated XHTML-Print data;
a buffer for temporarily storing the analyzed XHTML-Print data; and
a printing engine unit for printing the image layout.
